(19) United States
(12) Patent Application Publication
(10) Pub. No.: US 2021/0304927 A1
(43) Pub. Date: Sep. 30, 2021

(54) COMMON POTENTIOMETER WITH MULTIPLE ANGULAR INPUTS

(71) Applicant: DENSO International America, Inc., Southfield, MI (US)

(72) Inventors: Young Kwon LEE, Canton, MI (US); Shogo KONDO, Kariya-city (JP); Matthew PORTER, Farmington Hills, MI (US); Keniel BROWN, Ferndale, MI (US); Yoshifumi TAKAMOTO, Higashiura (JP)

(21) Appl. No.: 16/835,363

(22) Filed: Mar. 31, 2020

(51) Int. Cl. H01C 10/32; H01C 1/01; H01C 1/14; F24F 11/88

(52) U.S. Cl. CPC H01C 10/32; F24F 11/88; H01C 1/14; H01C 1/01

(57) ABSTRACT

A single turn potentiometer sensor has a substrate, a first and a second carbon print. The first carbon print, with a desired width, extends across a large circumferential angle. Ends of the carbon print are connected to a regulated power supply and ground. The second carbon print, with a width smaller than the first carbon print, surrounds a hole in the substrate and is positioned inside the first carbon print. The second carbon print provides a sensor output. A wiper contacts between the first and second carbon prints. A voltage divider changes value based on a wiper position on the first carbon print. One or more pads are positioned on the first carbon print. The one or more pads provides an input voltage to the sensor.

### FIELD

The present disclosure relates to potentiometers and, more particularly, to a common potentiometer with multiple angular inputs.

### BACKGROUND

Existing single turn potentiometer sensors used, for example, in HVAC door actuators, have a single defined travel angle. This single angle provides a position of the actuator by a zero to 5V feedback. Several variations of actuators with different potentiometer travel angles exist for each HVAC based operational travel requirements of each door. Also, between each HVAC design, different operational angles may be needed that further drive variation in the travel angles. The variation in the travel angle based on operational angle is required due to a loss of resolution of position in a potentiometer travel angle that is much larger than the required operational angle. Each variation in potentiometer travel angle drives a unique potentiometer sub-component and actuator part, thereby driving up cost and complexity. Thus, it would be desirable to provide a single potentiometer sensor with variable operational angles.

### SUMMARY

The present disclosures provides a single potentiometer sensor that, through partitioning, accommodates several travel angles in a single potentiometer sensor assembly. This common potentiometer assembly will enable a single actuator assembly to support multiple operating angles. Standardization of the sensor reduces actuator sub-component variation and complexity of the actuator assembly. This provides a potential cost reduction, which benefits part cost, associated assembly costs, and anti-mixing measures on the assembly lines of parts onto which an actuator may be mounted.

The present disclosure enables a single-turn potentiometer sensor to have partitions that enable sensor use across a wide range of operating angles without significant compromise of actuator position resolution. Multiple angle support in a single potentiometer sensor assembly will reduce actuator assembly complexity. This enables a single actuator assembly to support multiple operating angle ranges.

According to a first aspect of the disclosure, a single turn potentiometer sensor comprises a substrate with a first carbon print, with a desired width, across a large circumferential angle. Ends of the carbon print are connected to a regulated power supply and ground. A second carbon print, with a smaller width, surrounds a hole in the substrate. The second carbon print is positioned on the substrate inside the first carbon print. The second carbon print lead is to a terminal to provide a sensor output. A wiper is provided to contact between the first and second carbon prints. A voltage divider created by the wiper through contact with the first carbon print and the second carbon print changes value based upon the wipers position on the first carbon print. One or more pads are positioned on the first carbon print. The one or more pads each include a terminal. The terminal provides an input voltage to the sensor. The one or more pads can be asymmetrically or systematically positioned at intervals along the first carbon print. The sensor output changes from zero volts to a maximum voltage (example 5V), the input voltage at the pad to identify the position of the wiper on the first carbon print. Generally, two or more pads are provided.

According to a second aspect of the disclosure, the above potentiometer is utilized to control a door for a vehicle HVAC or other actuator driver assembly where position is determined using a potentiometer feedback voltage.

According to a third aspect of the disclosure, a method comprises controlling an actuator for a door of an HVAC system or other applicable position based actuator driven systems by a sensor output voltage generated by a single turn potentiometer sensor. The single turn potentiometer sensor design is executed as defined above.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a potentiometer or variable resistor.

FIG. 2 is an exploded view of FIG. 1.

FIG. 3 is planar view of the substrate.

FIG. 4 is a graph of the output characteristics.

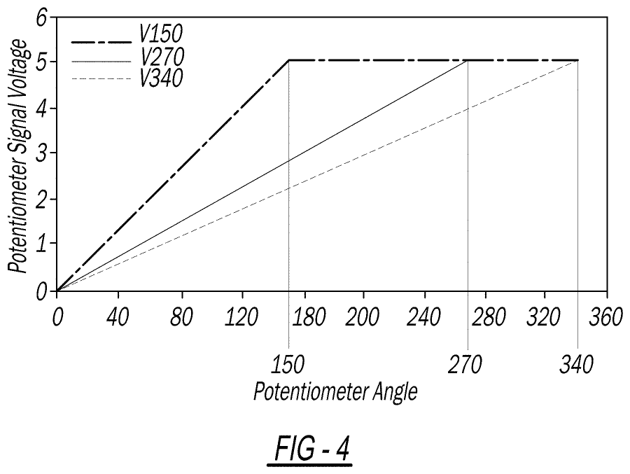

### DETAILED DESCRIPTION

Example embodiments will now be described more fully with reference to the accompanying drawings.

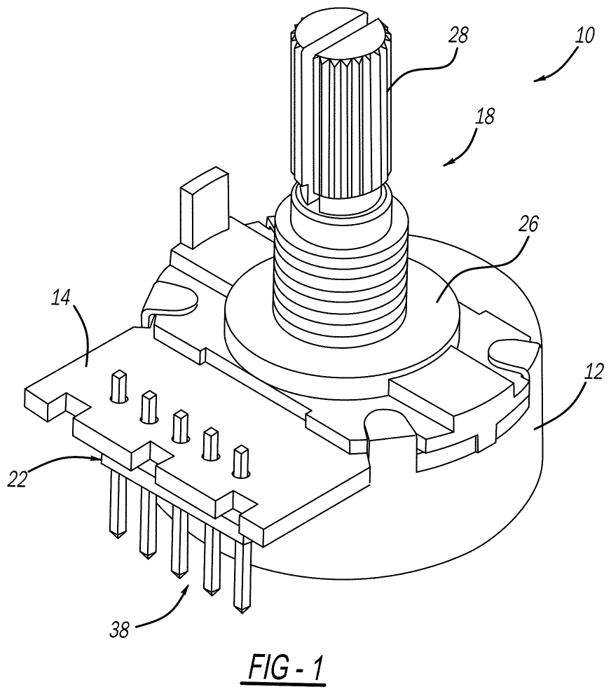

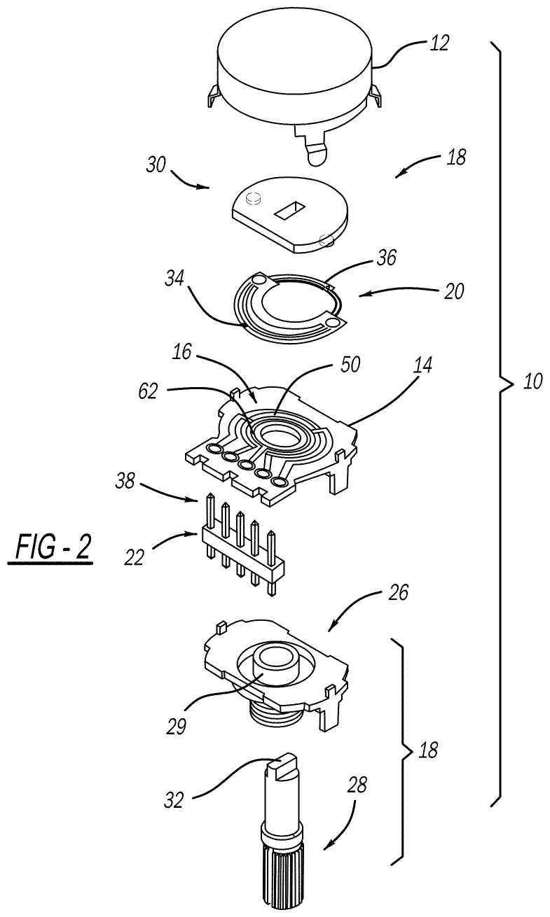

Turning to FIGS. 1, 2, and 3 a potentiometer is illustrated and designated with the reference numeral 10. It includes a casing 12, a substrate 14, a resistant element 16, a rotor assembly 18, a wiper 20 and a pin assembly 22. The casing 12 has an open end that may include multiple clamping tabs.

The rotary assembly 18 is mounted on the substrate 14 and is attached to the casing 12. The rotary assembly 18 includes a shaft mount 26, a shaft 28 and a wiper mount 30. The shaft mount 26 is mounted to the substrate 14 and may be clamped by the tabs to the casing. The shaft mount 26 includes a bushing 29 positioned through a hole 64 in the substrate. The shaft 28 is mounted through the bushing and has a connecting end 32 that mounts in the wiper mount 30. The wiper mount 30 is rotated by the shaft 28.

The wiper 20 is attached and rotated by the rotary assembly 18. The wiper has a first contact 34 and a second contact 36.

The pin assembly 22 is mounted on the substrate 14. The multiple pins 38 extend through openings in the substrate 14. The pins 38 are soldered or press-fit onto the connectors.

The substrate 14 provides a single turn potentiometer sensor with a resistant element 16 including a large carbon print 50 across a large circumferential angle, for example, 340°. The ends 52, 54 of the print 50 are connected by a trace 56 leading to terminals 58, 60. The terminal 58 is connected to a regulated power supply, for example, a 5 volt input, and the terminal 60 is connected to ground.

A smaller carbon print 62 is positioned inside of the larger carbon print 50. The second smaller carbon print 62 surrounds a hole 64 in the substrate 14. The small carbon print 62 connects to a trace 57 that leads to a terminal 66. The second smaller carbon print provides the sensor output, zero to 5V.

The wiper 20 has leads 34, 36 that contact between the smaller and larger carbon prints 62, 50, respectively. This creates a voltage divider that changes the voltage value for instance from 0V to 5V based on the wiper position on the large carbon print.

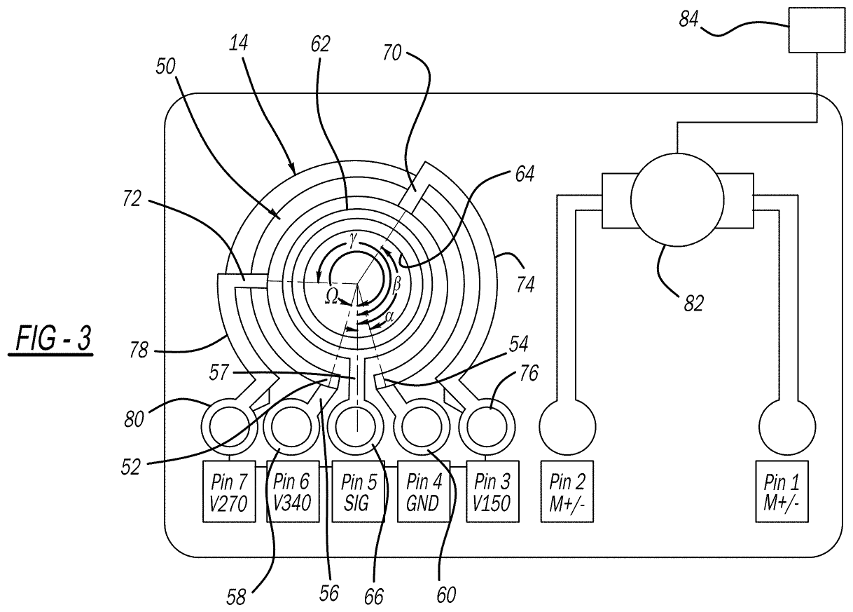

At predefined/asymmetrical/symmetrical intervals, shown in FIG. 3 as 3 inputs as 150 degrees, 270 degrees, 340 degrees are an example of the design. However, more or less intervals could be used to provide more position adjustment flexibility for actuator assemblies.

At the desired degree angles, a pad will be positioned on the large carbon print 50. Pads 70, 72 are illustrated. The pads 70 include a trace 74 that connects with terminal 76. Likewise, pad 72 includes trace 78 that connect with terminal 80. These traces 74, 78 are electrically coupled to additional terminals on the sensor to provide a required input voltage for the application.

During operation, only one pad and trace will be connected to the required input voltage on the potentiometer sensor. For example if a 5V input is connected to terminal 76, the voltage divider will produce a characteristic starting from angle α and rotating counter-clockwise towards angle β. The voltage output on terminal 66 will begin at 0V and will linearly increase until angle β is reached. Once reached, the output voltage on terminal 66 will be 5V (equivalent to input voltage). Any movement beyond angle β in the counter-clockwise direction, while the 5V input is connected to terminal 76, will produce a 5V output until angle θ is reached where the resistive track finishes. The above characteristic is shown in FIG. 3 “V150”.

Similarly, if the 5V input is connected to terminal 80, the voltage divider will produce a characteristic starting from angle α and rotating counter-clockwise towards angle γ. The voltage output on terminal 66 will begin at 0V and will linearly increase until angle γ is reached. Once reached, the output voltage on terminal 66 will be 5V (equivalent to input voltage). Any movement beyond angle γ in the counter-clockwise direction, while the 5V input is connected to terminal 80, will produce a 5V output until angle θ is reached where the resistive track finishes. The above characteristic is shown in FIG. 3 “V270”.

Finally, based on the example design if the 5V input is connected to terminal 58, the voltage divider will produce a characteristic starting from angle α and rotating counterclockwise towards angle θ. The voltage output on terminal 66 will begin at 0V and will linearly increase until angle θ is reached. Once reached, the output voltage on terminal 66 will be 5V (equivalent to input voltage). Any movement beyond angle θ will create an open circuit by wiper exiting the large carbon print 50. The above characteristic is shown in FIG. 3 “V340”.

Thus, based on the signal received from the potentiometer, the motor 82 will be activated which, in turn, would rotate the door 84 of the HVAC system or other application positioned based actuator driven systems.

A single turn potentiometer sensor is disclosed and includes a substrate and a first carbon print across a large circumferential angle, with ends of the first carbon print being connected to a regulated power supply and ground. The single turn potentiometer sensor also includes a second carbon print surrounding a hole in the substrate, the second carbon print positioned on the substrate inside the first carbon print, the second carbon print leading to a terminal, and the second carbon print providing a sensor output voltage. The single turn potentiometer also includes a wiper providing contact between the first and second carbon prints and providing a voltage divider that changes value based on a wiper position on the first carbon print. The single turn potentiometer also includes one or more pads positioned on the first carbon print, the one or more pads each including a terminal, the terminal providing an input voltage to the single turn potentiometer sensor.

In other features, the one or more pads are asymmetrically or systematically positioned at intervals along the first carbon print.

In other features, the sensor output voltage changes from zero to the input voltage at the one or more pads to identify position of the wiper on the first carbon print.

In other features, two or more pads are provided.

In other features, the sensor output voltage is utilized to manipulate a door of an HVAC system or other application position based actuator driven systems.

A system is also disclosed and includes a single turn potentiometer sensor. The single turn potentiometer includes a substrate and a first carbon print across a large circumferential angle, ends of the first carbon print being connected to a regulated power supply and ground. The single turn potentiometer also includes a second carbon print surrounding a hole in the substrate, the second carbon print positioned on the substrate inside the first carbon print, the second carbon print leading to a terminal, and the second carbon print providing a sensor output voltage. The single turn potentiometer also includes a wiper providing contact between the first and second carbon prints and providing a voltage divider that changes value based on a wiper position on the first carbon print. The single turn potentiometer also includes one or more pads positioned on the first carbon print, the one or more pads each including a terminal, the terminal providing an input voltage to the single turn potentiometer sensor. The system also includes a door of an HVAC system including an actuator, with the sensor output voltage being utilized to control the actuator and manipulate the door of the HVAC system or other application position based actuator driven systems.

In other features, the one or more pads are one of asymmetrically or systematically positioned at intervals along the first carbon print.

In other features, the sensor output voltage changes from zero to the input voltage at the one or more pads to identify the position of the wiper on the first carbon print.

In other features, two or more pads are provided.

A method is also disclosed and includes controlling an actuator for a door of an HVAC system or other application position based actuator driven systems with a sensor output voltage generated by a single turn potentiometer sensor. The single turn potentiometer sensor includes a substrate and a first carbon print across a large circumferential angle, with ends of the first carbon print being connected to a regulated power supply and ground. The single turn potentiometer sensor also includes a second carbon print surrounding a hole in the substrate, the second carbon print being positioned on the substrate inside the first carbon print, the second carbon print leading to a terminal, and the second carbon print providing the sensor output voltage. The single turn potentiometer sensor also includes a wiper providing contact between the first and second carbon prints and providing a voltage divider that changes value based on a wiper position on the first carbon print. The single turn potentiometer sensor also includes one or more pads positioned on the first carbon print, the one or more pads each including a terminal, the terminal providing an input voltage to the single turn potentiometer sensor.

In other features, the one or more pads are one of asymmetrically or systematically positioned at intervals along the first carbon print.

In other features, the sensor output voltage changes from zero to the input voltage at the one or more pads to identify the position of the wiper on the first carbon print.

In other features, two or more pads are provided.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A single turn potentiometer sensor comprising:
a substrate;
a first carbon print across a large circumferential angle, ends of the first carbon print being connected to a regulated power supply and ground;
a second carbon print surrounding a hole in the substrate, the second carbon print positioned on the substrate inside the first carbon print, the second carbon print leading to a terminal, and the second carbon print providing a sensor output voltage;
a wiper providing contact between the first and second carbon prints and providing a voltage divider that changes value based on a wiper position on the first carbon print; and
one or more pads positioned on the first carbon print, the one or more pads each including a terminal, the terminal providing an input voltage to the single turn potentiometer sensor.

2. The single turn potentiometer sensor of claim 1, wherein the one or more pads are asymmetrically or systematically positioned at intervals along the first carbon print.

3. The single turn potentiometer sensor of claim 1, wherein the sensor output voltage changes from zero to the input voltage at the one or more pads to identify position of the wiper on the first carbon print.

4. The single turn potentiometer sensor of claim 1, wherein two or more pads are provided.

5. The single turn potentiometer sensor of claim 1, the sensor output voltage is utilized to manipulate a door of an HVAC system or other application position based actuator driven systems.

6. A system comprising:
a single turn potentiometer sensor including:
a substrate;
a first carbon print across a large circumferential angle, ends of the first carbon print being connected to a regulated power supply and ground;
a second carbon print surrounding a hole in the substrate, the second carbon print positioned on the substrate inside the first carbon print, the second carbon print leading to a terminal, and the second carbon print providing a sensor output voltage;
a wiper providing contact between the first and second carbon prints and providing a voltage divider that changes value based on a wiper position on the first carbon print; and
one or more pads positioned on the first carbon print, the one or more pads each including a terminal, the terminal providing an input voltage to the single turn potentiometer sensor; and
a door of an HVAC system including an actuator, the sensor output voltage being utilized to control the actuator and manipulate the door of the HVAC system or other application position based actuator driven systems.

7. The system of claim 6, wherein the one or more pads are one of asymmetrically or systematically positioned at intervals along the first carbon print.

8. The system of claim 6, wherein the sensor output voltage changes from zero to the input voltage at the one or more pads to identify the position of the wiper on the first carbon print.

9. The system of claim 6, wherein two or more pads are provided.

10. A method comprising:
controlling an actuator for a door of an HVAC system or other applicable position based actuator driven systems with a sensor output voltage generated by a single turn potentiometer sensor, the single turn potentiometer sensor including:
a substrate;
a first carbon print across a large circumferential angle, ends of the first carbon print being connected to a regulated power supply and ground;
a second carbon print surrounding a hole in the substrate, the second carbon print positioned on the substrate inside the first carbon print, the second carbon print leading to a terminal, and the second carbon print providing the sensor output voltage;
a wiper providing contact between the first and second carbon prints and providing a voltage divider that changes value based on a wiper position on the first carbon print; and
one or more pads positioned on the first carbon print, the one or more pads each including a terminal, the terminal providing an input voltage to the single turn potentiometer sensor.

11. The method of claim 10, wherein the one or more pads are one of asymmetrically or systematically positioned at intervals along the first carbon print.

12. The method of claim 10, wherein the sensor output voltage changes from zero to the input voltage at the one or more pads to identify the position of the wiper on the first carbon print.

13. The method of claim 10, wherein two or more pads are provided.
